(19) United States
(12) Patent Application Publication
(10) Pub. No.: US 2010/0161344 A1
(43) Pub. Date: Jun. 24, 2010

(54) METHODS AND APPARATUS TO PREPARE REPORT REQUESTS

(76) Inventor: David S. Dyson, Vincentown, NJ (US)

Correspondence Address: Hanley, Flight & Zimmerman, LLC, 150 S. Wacker Dr. Suite 2100, Chicago, IL, 60606, US

(21) Appl. No.: 12/636,183

(22) Filed: Dec. 11, 2009

Related U.S. Application Data
(60) Provisional application No. 61/122,208, filed on Dec. 12, 2008.

(51) Int. Cl. G06F 17/30; G06Q 10/00; G06F 3/048

(52) U.S. Cl. 705/1.1; 707/769; 715/843; 715/764; 707/E17.014

(57) ABSTRACT

Example methods and apparatus to prepare report requests are disclosed. A disclosed example method includes receiving a request to generate a report, the request associated with selection criteria, receiving a report specification associated with the selection criteria, and parsing the report specification to identify a report directive. The example method also includes querying a report directive library to retrieve instructions associated with the identified report directive, executing the retrieved instructions to modify the report specification based on the selection criteria, and generating an output including the modified report specification.

### RELATED APPLICATION

This patent claims the benefit of U.S. Provisional application Ser. No. 61/122,208, filed on Dec. 12, 2008, which is hereby incorporated by reference herein in its entirety.

### FIELD OF THE DISCLOSURE

This disclosure relates generally to Business Intelligence (BI) systems and, more particularly, to methods and apparatus to prepare report requests.

### BACKGROUND

Market data analysis techniques are often performed when making development and planning decisions in many businesses. Businesses often use data analysis software to perform different types of market analyses. To specify particular analyses or to retrieve analysis results from a data source, the data analysis software often provides a user interface that enables users to search for desired data or type of data by specifying particular criteria. The available criteria or type of data may change between different data sources so that when users wish to view data or data analyses from different data sources, the user needs to re-select or re-specify criteria that is pertinent to the particular data source of interest.

Additionally, some data sources prevent direct access to report data unless one or more requests are performed via a detailed report specification. The report specification may include specific commands and/or syntax that invokes targeted functionality. If a user needs to run one or more reports, each having significant or minor changes, a new report specification is usually designed and submitted to the user interface, which may consume significant amounts of time and/or involve programming resources.

### BRIEF DESCRIPTION OF THE DRAWINGS

FIG. 1 depicts an example graphical user interface of an application used to retrieve report information from a plurality of separate data sources without requiring a user to repeatedly provide selection criteria indicative of the information to be retrieved.

FIG. 2 is a block diagram of an example system configured to retrieve information from a plurality of data sources.

FIG. 3 is an example table of contents that may be used to implement the table of contents of FIG. 2.

FIG. 4 depicts an example table of contents written in an extensible markup language (XML) that may be used to implement the example table of contents of FIG. 3.

FIG. 5 depicts an example mapping table format that may be used to implement the mapping table of FIG. 2.

FIG. 6 is an example mapping table data structure implemented in accordance with the example mapping table format of FIG. 5.

FIG. 7 is an example timing diagram representative of example communication transactions between entities of the example system of FIG. 2.

FIG. 8 is a flowchart representative of example machine readable instructions that may be executed by one or more entities of the example system of FIG. 2 to enable the application of FIG. 1 to retrieve information from a plurality of separate data sources without requiring a user to repeatedly provide selection criteria indicative of the information to be retrieved.

FIG. 9 is a block diagram of an example system configured to retrieve information from a plurality of data sources and generate a report specification.

FIGS. 10A-C depict example portions of a report specification written in an extensible markup language (XML) that may be used to implement the example report directives described herein.

FIG. 11 is a block diagram of the normative report engine of FIG. 9.

FIG. 12 is a flowchart representative of example machine readable instructions that may be executed by one or more entities of the example system of FIG. 9 to prepare report requests.

FIG. 13 is a block diagram of an example processor system that may be used to execute the example machine readable instructions of FIGS. 8 and 12 to implement the example systems, apparatus, and/or methods described herein.

### DETAILED DESCRIPTION

### Context Management

The example systems, methods, apparatus, and/or articles of manufacture described herein may be used to enable an application to retrieve information from two or more (i.e., a plurality) of separate data sources without requiring a user to repeatedly provide selection criteria indicative of the information to be retrieved. In particular, the example systems, methods, and apparatus described herein provide an application the ability to receive user-provided selection criteria from a user, to store (e.g., persist, save, etc.) the user-provided selection criteria, and to subsequently use the user-provided selection criteria a plurality of times to retrieve information from a plurality of separate (e.g., different) data sources in response to, for example, the user requesting to view the information.

Example methods and apparatus to prepare report requests are disclosed. A disclosed example method includes receiving a request to generate a report, the request associated with selection criteria, receiving a report specification associated with the selection criteria, and parsing the report specification to identify a report directive. The example method also includes querying a report directive library to retrieve instructions associated with the identified report directive, executing the retrieved instructions to modify the report specification based on the selection criteria, and generating an output including the modified report specification.

An example apparatus includes a portal to receive a request to generate a report, a context service interface to receive selection criteria associated with the request to generate the report, and a report specification repository to store a plurality of report specifications, the context service interface to retrieve a report specification from the plurality of report specifications from the report specification repository. The example apparatus also includes a normative report engine to parse the report specification for a report directive, and a report directive processor to execute the report directive, the report directive to modify the report based on the received selection criteria.

In an example implementation, the example systems, methods, and apparatus described herein may be used to implement a user-accessible network-based or web-based portal (e.g., an information retrieval application) configured to access and retrieve information from a plurality of data sources and to display the information to a user. As used herein, data sources include, for example, databases, servers, applications, data structures, storage areas, or any other device, system, or process that can store and/or communicate requested information to an information retrieval application. In an example implementation used to conduct business research or market research, the user-accessible web-based portal (i.e., the portal) can be configured to display the retrieved information in, for example, report formats or in any other format (e.g., charts, paragraphs, tables, etc.) to enable a user to view the requested information. For example, a user could specify selection criteria indicative of a particular market (e.g., a geographic area, an age group, etc.) to view a particular user-specified or default report (e.g., revenues report, quantities sold report, etc.) based on the selection criteria. The portal can then retrieve the information corresponding to the user-specified selection criteria and store the user-specified selection criteria for subsequent use. That is, when the user requests to view other types of reports based on the same selection criteria, the user need not re-enter the selection criteria. Instead, the portal can use the stored user-provided selection criteria to retrieve information for any report subsequently requested by the user. To view a different report, the user merely specifies the report of interest, and the portal then automatically uses the stored user-provided selection criteria to retrieve the information for the requested report from a data source.

In some example implementations, some data sources are native data sources and other data sources are normative data sources (e.g., external data sources). As used herein, a native data source is configured to store and communicate information using a substantially similar or identical format or data arrangement as other native data sources and/or a data retrieval application (e.g., a portal). In addition, each of the native data sources may be configured to use the same or substantially the same data access interface protocol or data access interface format to enable an information retrieval application (e.g., a portal) to request information and receive information from any native data source using the same data format and/or data access interface protocol. The example systems, methods, and/or apparatus described herein can be used to retrieve information based on user-provided selection criteria from native and/or normative data sources.

An example method of retrieving information involves receiving a selection criterion (e.g., a native selection criterion) associated with information stored in a native data source, storing the native selection criterion in a first data structure, and associating an identifier (ID) with the first data structure. To retrieve information from a normative data source based on the native selection criterion, a mapped data structure is generated based on the ID by mapping the native selection criterion to a normative selection criterion associated with the information stored in the normative data source. The information is then retrieved from the normative data source based on the normative selection criterion in the mapped data structure.

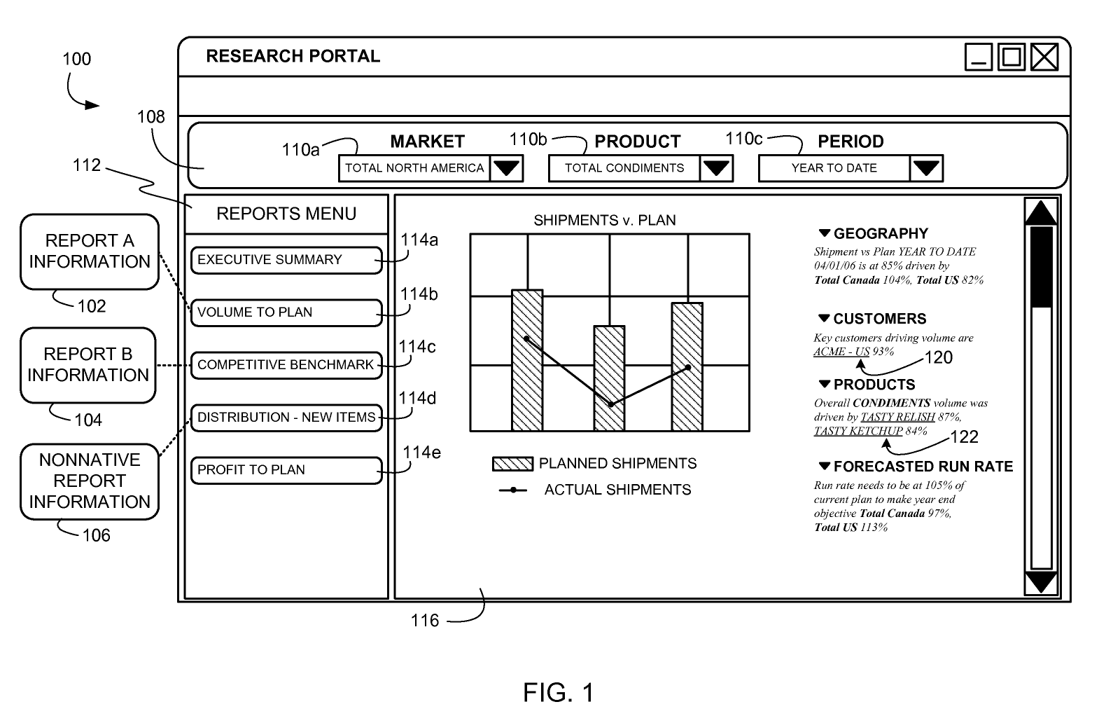

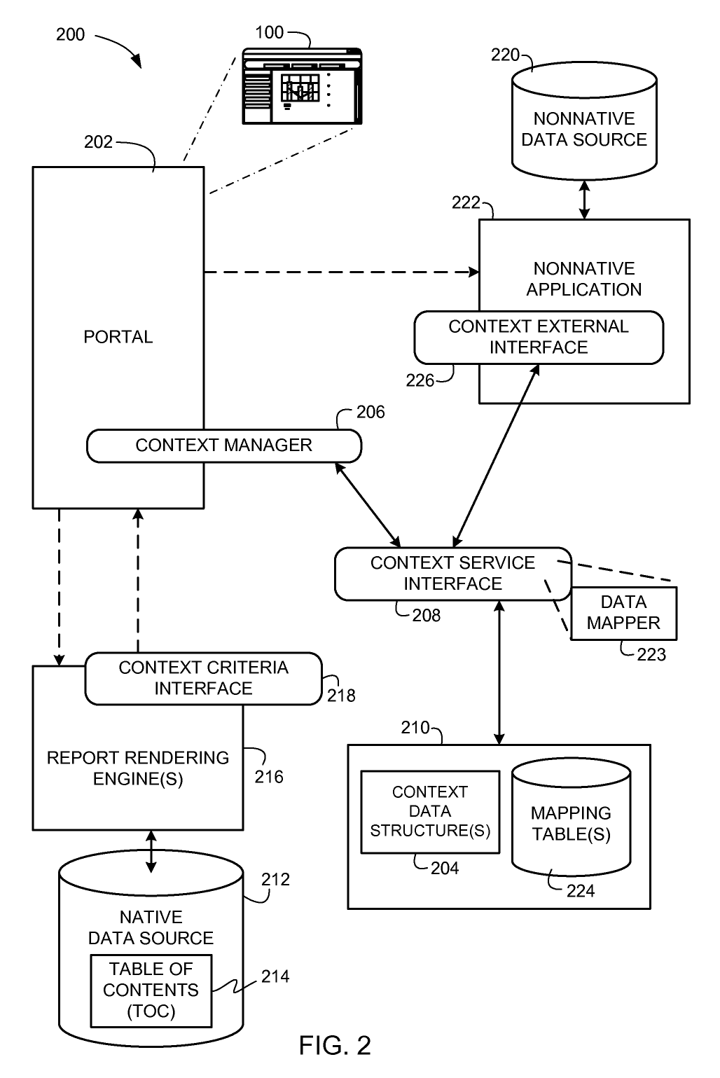

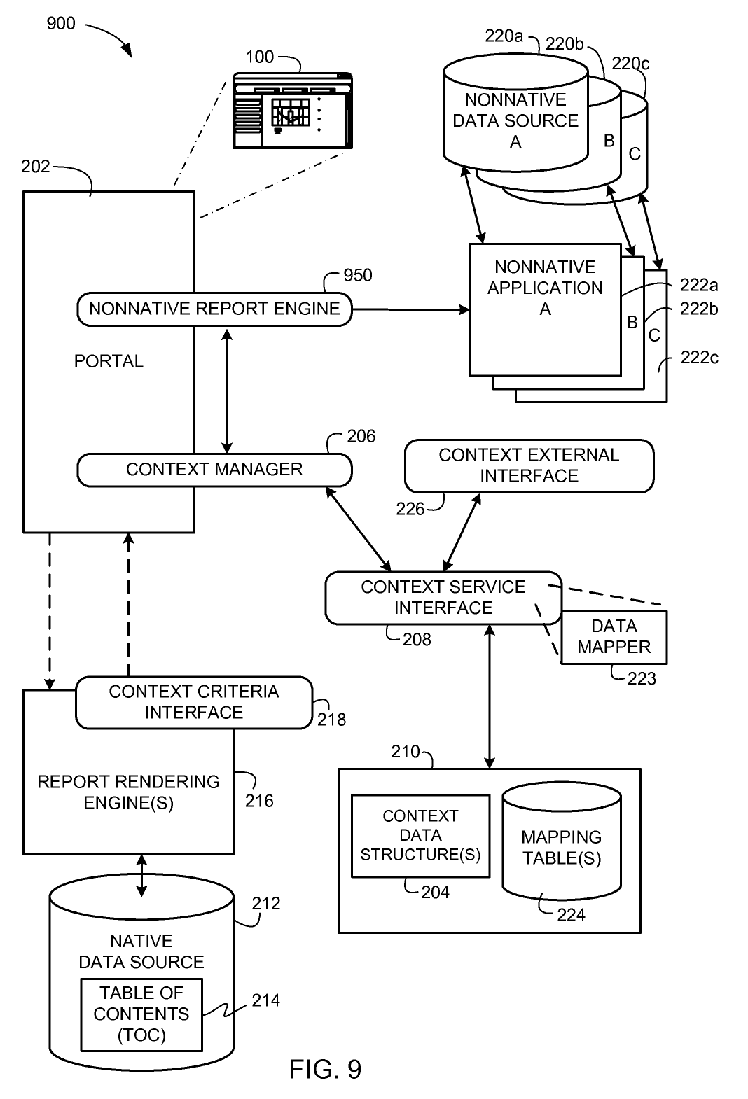

FIG. 1 depicts an example graphical user interface (GUI) 100 of an information retrieval application (e.g., the portal 202 of FIGS. 2 and 9) used to retrieve report information 102, 104, and/or 106 from a plurality of separate data sources (e.g., data sources 212 and 220 of FIG. 2) without requiring a user to repeatedly provide selection criteria indicative of the information to be retrieved. To enable a user to specify selection criteria indicative of the information that the user would like to view, the GUI 100 is provided with a criteria selection toolbar 108 having a plurality of criterion selection fields 110a-c. The criterion selection fields 110a-c provide a plurality of criteria from which a user may select. As described in greater detail below, available selection criteria are provided to the criterion selection fields 110a-c using tables of contents (TOC) provided by data sources. Each data source is typically associated with a respective TOC that indicates the type of information that may be retrieved from that data source. For example, a data source having information associated with fast food restaurant sales may provide a TOC having selection criteria associated with, for example, regions of fast food sales, types of fast food sold, etc. In some example implementations, a data source may be associated with a plurality of TOC, each of which corresponds to a different user or user account having access (e.g., login access, data access, etc.) to the data source. The selection criteria included in each TOC may vary based on respective user accounts. For example, a user account may indicate permissible access to information associated with only a subset of selection criteria (e.g., condiment sales volume and revenue) associated with a respective data source (e.g., a data source that stores sales volumes and revenues for many different types of foods). Thus, for a particular data source, a user account may be uniquely associated with a TOC having a subset of selection criteria different from another TOC.

In the illustrated example, the criterion selection fields 110a-c are implemented using drop-down lists. In the illustrated example, a drop-down list displays selection criteria available to a user when the user clicks on the drop-down list. However, in other example implementations, the selection criterion fields 110a-c may be implemented using any other GUI control. In addition, although three criterion selection fields 110a-c are shown, the criteria selection toolbar 108 may be provided with any number of criterion selection fields 110a-c. For example, the criteria selection toolbar 108 may have one or more criterion selection fields.

To enable a user to select a type of report to view based on the user-specified criteria selected via the criteria selection toolbar 108, the GUI 100 is provided with a reports menu 112. The reports menu 112 includes a plurality of report selectors 114a-e. Each of the report selectors 114a-e corresponds to a particular data source. As described in further detail below, selection of the example report selectors 114a-e is passed as selection context information to enable the methods and apparatus described herein to, in part, prepare one or more report specifications for one or more target third-party report generators. In the illustrated example, the ‘Volume to Plan’ report selector 114b corresponds to a native data source configured to provide the report A information 102, the ‘Competitive Benchmark’ report selector 114c corresponds to a native data source configured to provide the report B information 104, and the ‘Distribution-New Items’ report selector 114d corresponds to a normative data source configured to provide the normative report information 106.

In an example implementation, after a report is selected (e.g., a user selects one of the report selectors 114a-e or a default report is enabled upon initial login based on user account default settings), the data source configured to provide the selected report can provide its TOC to populate the available selection criteria in the criterion selection fields 110a-c. A user can then specify one or more criterion via the criteria selection toolbar 108 and one of the report selectors 114a-e to retrieve information based on the user-provided criteria from a data source corresponding to the selected one of the report selectors 114a-e. In some example implementations, native data sources may be configured to have the same criteria (e.g., native criteria) in their TOC. That is, the selection criteria from which a user can select to retrieve information from a native data source may be the same for all of the native data sources. For example, if the criterion selection fields 110a-c include native selection criteria common to native data sources associated with the report selectors 114b-c and a user specifies ‘Total North America,’ ‘Total Condiments,’ and ‘Year to Date’ in the criteria selection toolbar 108, an information retrieval application (e.g., the portal 202 of FIGS. 2 and 9) can use the specified native selection criteria to retrieve report information from any or all of the native data sources without mapping the selection criteria associated with one native data source to selection criteria associated with another native data source.

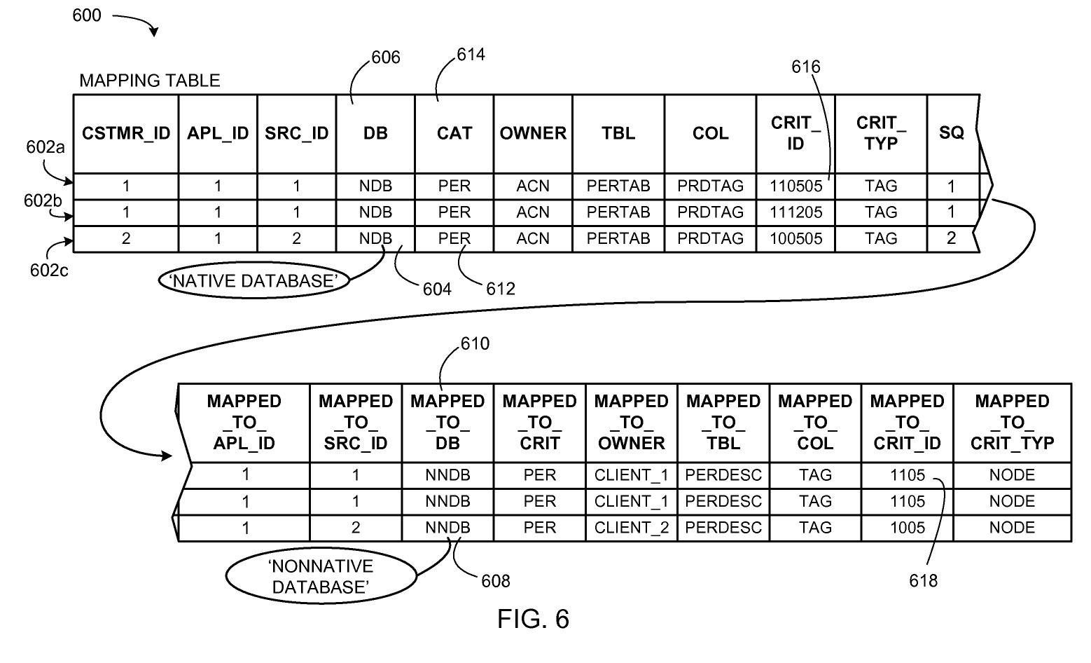

In some example implementations, the TOC for normative data sources may contain selection criteria (e.g., normative selection criteria) different from the selection criteria associated with the native data sources. Thus, in the illustrated example, when the user selects the ‘Distribution-New Items’ report selector 114d while viewing the report A information 102, the user-specified criteria (e.g., the criteria available for the report A information 102) specified via the criteria selection toolbar 108 are stored and assigned an identifier (ID). The ID can then be used to map the specified native selection criteria to corresponding selection criteria (e.g., normative selection criteria) associated with the normative data source configured to provide the normative report information 106 using mapping tables (e.g., the mapping table 224 of FIGS. 2 and 9 and 600 of FIG. 6) as described below. If the user elects to change the selection criteria while viewing the normative report information 102, the selection criteria available via the criterion selection fields 110a-c will be indicative of the normative criteria associated with the normative data source that provided the normative report information 106. In addition to mapping native selection criteria to normative selection criteria, the example systems, methods, and apparatus described herein can also be used to map normative selection criteria to native selection criteria when a user navigates from normative report information (e.g., the normative report information 106) to native report information (e.g., the report A information 102 or the report B information 104).

To display report information, the GUI 100 is provided with a report display area 116. In the illustrated example, the report display area 116 is configured to display report information in chart format, graph format, pictorial format, and/or textual format. Also in the illustrated example, textual representations of report information may be configured to include user-selectable selection criteria 120 and 122. The selectable selection criteria 120 and 122 correspond to selection criteria that may also be available for selection via the criterion selection fields 110a-c. Thus, the selectable selection criteria 120 and 122 are provided by a data source via the TOC of that data source. When a user selects one of the selectable selection criteria 120 and 122, a corresponding one of the criterion selection fields 110a-c displays the text (e.g., ‘ACME-US’) corresponding to the selected one of the selectable selection criteria 120 and 122.

FIG. 2 is a block diagram of an example system 200 configured to retrieve information from a plurality of data sources to enable retrieving information from the plurality of data sources. To host the GUI 100 of FIG. 1 and retrieve information (e.g., the report information 102, 104, and 106 of FIG. 1) from native and/or normative data sources, the example system 200 is provided with a portal 202. Each time a user specifies different selection criteria via the criteria selection toolbar 108 (FIG. 1), the example portal 202 of FIG. 2 creates or instantiates a criteria context data structure 204 to store the selection criteria for use in retrieving any subsequent report information while the selection criteria remains unchanged. In the illustrated example, to generate context data structure(s), the portal 202 is provided with a context manager 206. The context manager 206 creates a context data structure (e.g., the context data structure 204) by pairing or associating a criterion type and a criterion identifier (ID) corresponding to each of the specified selection criterion to form one or more criterion type/ID pairs, referred to herein as context information. For example, if the user specifies the criterion ‘North America’ via the ‘Market’ criterion selection field 110a of FIG. 1, the context manager 206 creates a criterion type/ID pair for the selection that specifies ‘Market/North America,’ in which ‘Market’ corresponds to the criterion type and ‘North America’ corresponds to the criterion ID. When the user specifies different selection criteria, the context manager 206 creates a different context data structure to store the updated selection criteria. In the illustrated example, the context manager 206 is configured to create the criterion type/ID pairs (context information) using an extensible markup language (XML) format. That is, the context manager 206 creates an XML entry for each criterion type/ID pair corresponding to each specified selection criterion. However, any other format may alternatively be used to implement the criterion type/ID pairs.

It is preferable, but not necessary, that the context manager 206 be configured to create criterion type/ID pairs when a user selects to navigate from a native report to a normative report or to navigate from a normative report to a native report. It is also preferable, but not necessary, that the context manager 206 be configured not to create criterion type/ID pairs when a user selects to navigate between different native reports associated with the same selection criteria. For example, the context manager 206 may be configured to create the criterion type/ID pairs when the GUI 100 is displaying the report A information 102 (FIG. 1) and the user selects the ‘Distribution-New Items’ report selector 114d to view the normative report information 106 (FIG. 1). By way of further example, the context manager 206 may be configured not to create criterion type/ID pairs when the GUI 100 is displaying the report A information 102 and the user selects the ‘Competitive Information’ report selector 114c (FIG. 1) to view the native report B information 104 (FIG. 1).

To store the context data structure 204, the example system 200 is provided with a context service interface 208. When the context manager 206 generates the context data structure 204, the context manager 206 communicates the context data structure 204 to the context service interface 208. The context service interface 208 stores the context data structure 204 in, for example, a memory 210 and assigns the context data structure 204 a context ID. In this manner, the context manager 206 or any other entity in the example system 200 can reference the context data structure 204 using the context ID. In some example implementations, the context service interface 208 may be implemented using a web-based interface that enables the portal 202 to communicate with the context service interface 208 using a web communication protocol (e.g., hyper-text transfer protocol (HTTP)).

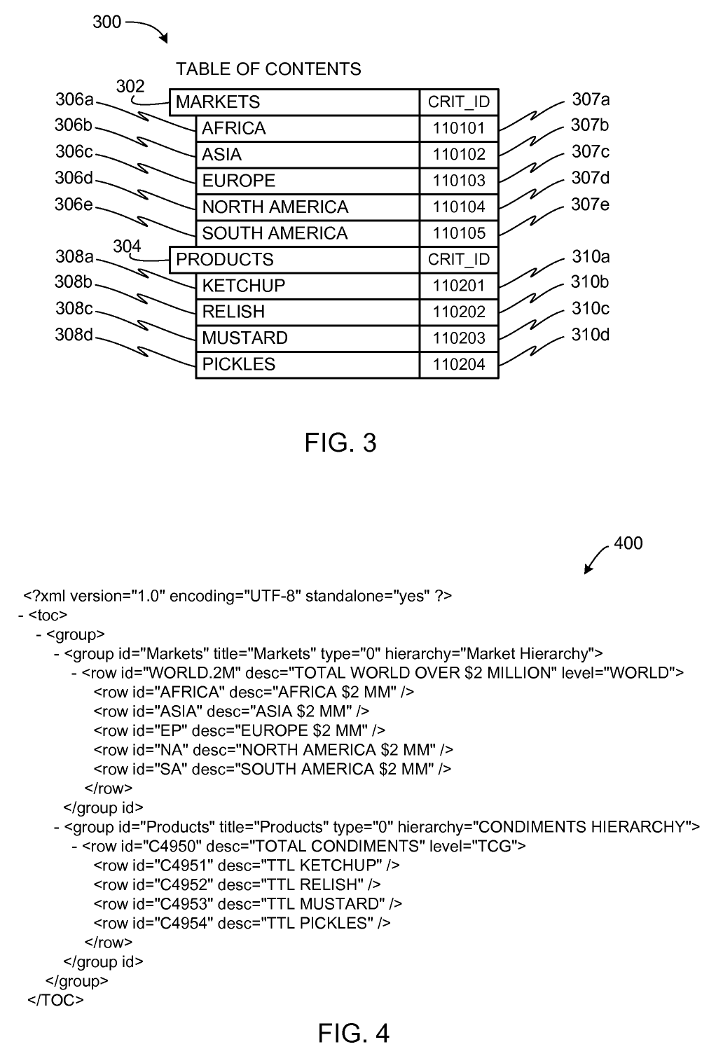

In the example of FIG. 2, a native data source 212 is provided to store and provide information (e.g., the report A information 102 and/or the report B information 104 of FIG. 1) requested by a user via the GUI 100. A table of contents (TOC) 214 stores the plurality of selectable selection criteria associated with the native data source 212. An example TOC representation and an example XML-coded TOC that may be used to implement the TOC 214 are shown in FIGS. 3 and 4, respectively. To render reports corresponding to information retrieved from the native data source 212, the example system 200 of FIG. 2 is provided with a report rendering engine 216. For example, the report rendering engine 216 may be configured to render reports using one or more of chart formats, graph formats, pictorial formats, textual formats, etc. and may be used to render, for example, reports such as those shown in the GUI 100 of FIG. 1. In the illustrated example, the report rendering engine 216 is a native application relative to the portal 202. The report rendering engine 216 is configured to communicate rendered reports to the portal 202 to enable the portal 202 to display the rendered reports via the GUI 100. In some example implementations, the report rendering engine 216 may be implemented using web-based technologies to enable the report rendering engine 216 to render reports displayable via a web page. Although for ease of illustration only one report rendering engine (e.g., the report rendering engine 216) is shown, any number of report rendering engines may be provided.

In the illustrated example, to communicate the TOC 214 having the selection criteria selectable for retrieving information from the native data source 212, the example system 200 is provided with a context criteria interface 218. For example, if the report A information 102 of FIG. 1 is stored in the native data source 212 and a user selects the ‘Volume to Plan’ report selector 114b of FIG. 1 (which corresponds to displaying the report A information 102), the context criteria interface 218 communicates the TOC 214 to the portal 202. In this manner, the portal 202 can populate selectable selection criteria in the criterion selection fields 110a-c of FIG. 1 to enable a user to specify selection criteria associated with the native data source 212.

In the illustrated example, a normative data source 220 (e.g., an external data source) is provided to store and provide normative report information (e.g., the normative report information 106 of FIG. 1) requested by a user via the GUI 100. A normative application 222 is provided to exchange normative report information between the portal 202 and the normative data source 220. The normative application 222 may be, for example, a SAP application that is configured to communicate with the normative data source 220 and receive information requests from other application(s) (e.g., the portal 202) to provide information from the normative data source 220 to those applications. In the illustrated example, although the normative data source 220 may be configured to provide a listing of its selectable selection criteria, the normative data source 220 may not necessarily provide the selection criteria listing via a TOC. However, in other example implementations, the normative data source 220 may have a TOC containing its selectable selection criteria defined using, for example, normative values (e.g., normative descriptions, normative keys, normative ID's, etc.).

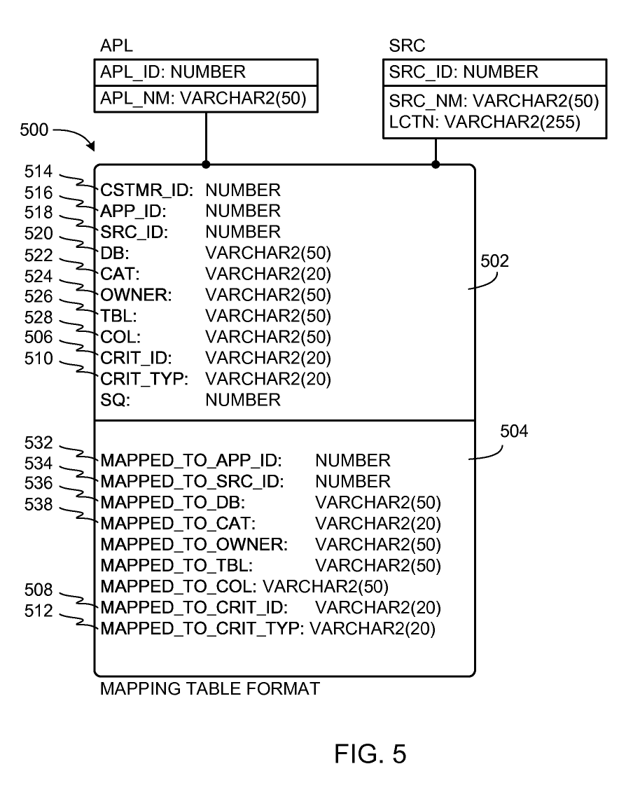

In the example of FIG. 2, the context service interface 208 is provided with a data mapper 223 configured to generate a mapping table 224, which provides a mapping of selection criteria associated with different data sources. In the illustrated example, the mapping table 224 maps native selection criteria corresponding to the native data source 212 to normative selection criteria corresponding to the normative data source 220. In an example implementation, the TOC 214 of the native data source 212 may include a native ‘North America Sales’ criterion corresponding to sales of every country in North America while the normative data source 220 may have a normative ‘United States’ criterion corresponding to sales information of only the United States. To enable a user to view normative report information (e.g., the normative report information 106 of FIG. 1) stored in the normative data source 220 based on the selected ‘North America Sales’ criterion associated with the TOC 214, the mapping table 224 maps the normative ‘United States’ criterion associated with the normative data source 220 to the native ‘North America Sales’ criterion associated with the native data source 212. In this manner, when the user requests to view the normative report information 106 based on the specified native ‘North American Sales’ criterion, the normative application 222 can retrieve the requested information from the normative data source 220 based on the normative ‘United States’ criterion indicated via the criterion mapping in the mapping table 224. An example mapping table format that may be used to implement the mapping table 224 is shown in FIG. 5. An example mapping table is shown in FIG. 6. Although for ease of illustration, only one mapping table (e.g., the mapping table 224) is shown in FIG. 2, the example system 200 may be provided with any number of mapping tables.

To enable the normative application 222 to retrieve requested information from the normative data source 220 based on the selection criteria specified via the criteria selection toolbar 108 (FIG. 1), the example system 200 of FIG. 2 is provided with a context external interface 226. For example, to retrieve the normative information 106 (FIG. 1) from the normative data source 220, the example portal 202 of FIG. 2 forwards a request to the normative application 222 including the context ID associated with the context data structure 204. The context external interface 226 then communicates the context ID to the context service interface 208 with a request to retrieve the normative selection criteria associated with the normative data source 220 that correspond to the user-specified native selection criteria stored in the context data structure 204. In the illustrated example, the normative selection criteria are mapped to the native selection criteria in the mapping table 224. In response to receiving the request from the context external interface 226, the context service interface 208 can retrieve the normative selection criteria from the mapping table 224 and communicate the normative selection criteria to the context external interface 226. In this manner, the normative application 222 can retrieve the normative report information 106 (FIG. 1) from the normative data source 220 corresponding to the native user-specified selection criteria specified via the GUI 100 and stored in the context data structure 204.

In the illustrated example, the context external interface 226 is also configured to communicate a normative TOC associated with the normative data source 220 to the portal 202 via the context service interface 208 to enable the portal 202 to populate the criteria selection toolbar 108 with available normative selection criteria associated with the normative data source 220. If the user subsequently selects to retrieve other normative information from the normative data source 220, the context external interface 226 can provide the requested information based on the normative selection criteria specified by the user via the criteria selection toolbar 108 without having to use a mapping between native and normative selection criteria again. That is, the data mapper 223 may be configured to map between native and normative selection criteria only when a user elects to navigate from a native report to a normative report or from a normative report to a native report. However, the data mapper 223 may be configured to not map between native and normative selection criteria when a user navigates to different normative reports that use normative information retrieved from the normative data source 220.

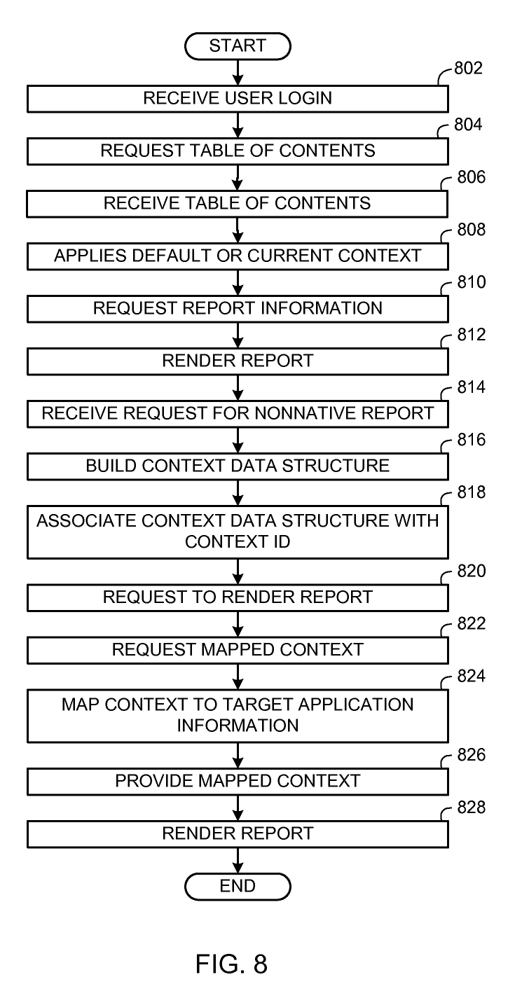

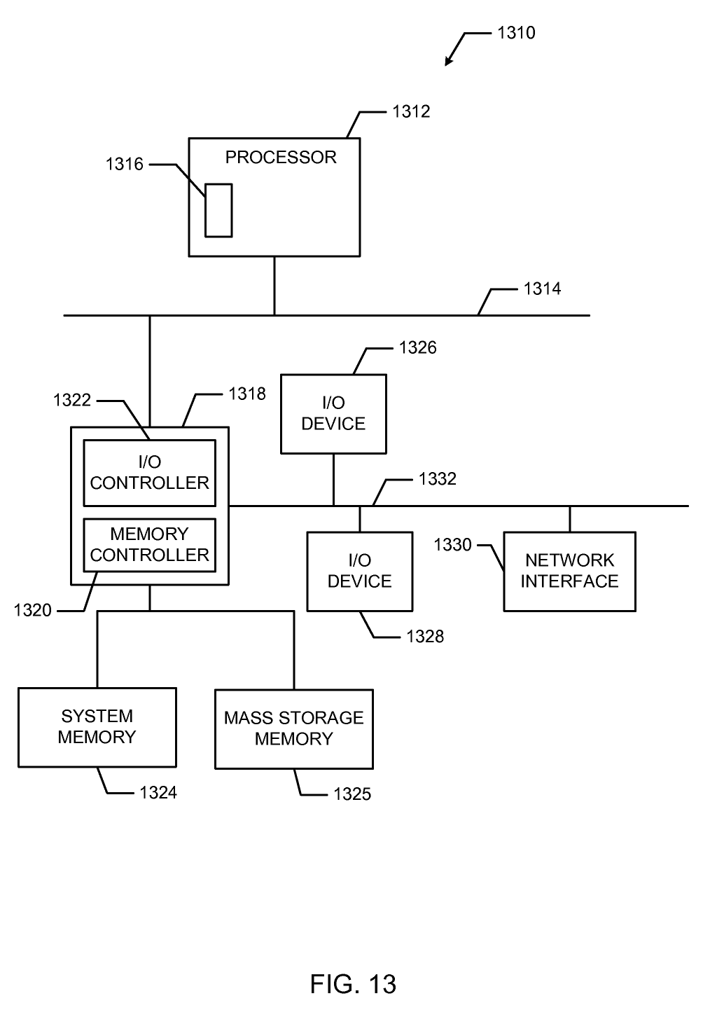

The context manager 206, the context service interface 208, the context criteria interface 218, the data mapper 223, and the context external interface 226 may be implemented using any desired combination of hardware, firmware, and/or software. For example, one or more integrated circuits, discrete semiconductor components, or passive electronic components may be used to implement these structures. Additionally or alternatively, some or all of the context manager 206, the context service interface 208, the context criteria interface 218, the context external interface 226, and/or parts thereof, may be implemented using instructions, code, and/or other software and/or firmware, etc. stored on a machine accessible medium that, when executed by, for example, a processor system (e.g., the example processor system 1310 of FIG. 13), perform the operations represented in the flowchart of FIG. 8. In the illustrated example, some or all of the context manager 206, the context service interface 208, the context criteria interface 218, and/or the context external interface 226 may be distributed among various network entities (e.g., various servers) in the example system 200. However, in alternative example implementations, some or all the context manager 206, the context service interface 208, the context criteria interface 218, and/or the context external interface 226 may be implemented using the same network entity (e.g., the same server).

FIG. 3 is an example table of contents 300 that may be used to implement the table of contents 214 of FIG. 2. In the illustrated example, the TOC 300 includes two types of criteria, namely, a markets criterion type 302 and a products criterion type 304. Under the markets criterion type 302, the TOC 300 includes a plurality of criteria 306a-e, each of which is associated with a unique criterion ID 307a-e. Under the products criterion type 304, the TOC 300 includes a plurality of criteria 308a-d, each of which is also associated with a unique criterion ID 310a-d. In the illustrated example, the portal 202 (FIG. 2) can use the criteria 306a-e and 308a-d to populate selectable criteria in the criterion selection fields 110a-c of FIG. 1. For example, the portal 202 may populate the ‘Market’ criterion selection field 110a with any or all of the criterion 306a-e and populate the ‘Product’ criterion selection field 110b with any or all of the criterion 308a-d. In this manner, when a user selects, for example, the ‘Market’ criterion selection field 110a, the criterion 306a-e are shown via a drop-down list. In an example implementation, the TOC 300 may be implemented using a TOC 400 implemented using XML as shown in FIG. 4.

FIG. 5 depicts an example mapping table format 500 that may be used to implement the mapping table 224 of FIG. 2. In the illustrated example, the example mapping table format 500 includes a native parameter portion 502 and a normative mapped parameter portion 504. Although the parameter portions 502 and 504 are described as corresponding to native and normative parameters, in other example implementations, the mapping table format 500 may be used to map selection criteria associated with different native data sources. For example, the mapping table format 500 could be used to map selection criteria associated with a first native data source to different selection criteria associated with a second native data source. In yet other example implementations, the mapping table format 500 may be used to map selection criteria associated with different normative data sources. For example, the mapping table format 500 could be used to map selection criteria associated with a first normative data source to different selection criteria associated with a second normative data source.

In the illustrated example of FIG. 5, the native parameter portion 502 includes a criterion ID parameter 506 that is mapped to a mapped-to criterion ID parameter 508 in the normative parameter portion 504. In addition, the native parameter portion 502 includes a criterion type parameter 510 that is mapped to a mapped-to criterion type parameter 512 in the normative mapped parameter portion 504. The criterion type parameter 510 may be used to indicate whether a criterion indicated by the criterion ID parameter 506 is, for example, a market criterion type (e.g., the markets criterion type 302 of FIG. 3) or a product criterion type (e.g., the products criterion type 304 of FIG. 3). Other criteria in the example mapping table format 500 of FIG. 5 include a customer ID 514 to indicate a customer (e.g., a user) of a portal service (e.g., a service provided by the portal 202 of FIG. 2), an application ID 516 to identify an application (e.g., a native application or the report rendering engine 216 of FIG. 2) corresponding to a particular mapping table entry, a source ID 518 to identify a data source (e.g., the native data source 212 of FIG. 2) corresponding to the particular mapping table entry, a database parameter 520 to indicate the name of the data source, a category parameter 522 to identify the categorical type (e.g., financial type information, volume type information, time-based information, etc.) of information stored by the data source, an owner parameter 524 to identify an owner of the data source, and a table parameter 526 and a column parameter 528 to identify a particular table and a column of the table within the data source in which the information corresponding to the mapped criterion is stored.

The normative mapped parameter portion 504 includes ‘mapped-to’ parameters corresponding to the parameters 506, 510, 516, 518, 520, 522, 524, 526, and 528. For example, a mapped-to application ID 532 is mapped to the application ID 516 and indicates the ID of a normative application (e.g., the normative application 222 of FIG. 2) to which a native application is mapped. A mapped-to source ID 534 is mapped to the source ID 518 and indicates the ID of a normative data source (e.g., the normative data source 220 of FIG. 2). A mapped-to database parameter 536 is mapped to the database parameter 520 and indicates the name of a normative data source (e.g., the normative data source 220). A mapped-to category parameter 538 is mapped to the category parameter 522 and indicates the name of a normative categorical type.

FIG. 6 is an example mapping table data structure 600 implemented in accordance with the example mapping table format 500 of FIG. 5. For simplicity of illustration, the example mapping table data structure 600 includes three mapping entries 602a-c. However, the example mapping table data structure 600 shown in FIG. 6 may include any number of mapping entries. In the illustrated example, the mapping table data structure 600 includes a ‘native database’ parameter value 604 in a database column 606 that is mapped to a ‘normative database’ parameter value 608 in a mapped-to-database column 610. The ‘native database’ parameter value 604 may correspond to the native data source 212 of FIG. 2 and the ‘normative database’ parameter value 608 may correspond to, for example, the normative data source 220 of FIG. 2.

In the illustrated example, the mapping entries 602a-c are used to map selection criteria associated with a time-based or period-based category as indicated by the period parameter 612 stored in a category column 614. The mapping entry 602a is used to map a native database criterion ID ‘110505’ 616 corresponding to a time period of Nov. 5, 2005 to a normative database criterion ID ‘1105’ 618 corresponding to a time period of November 2005. In the illustrated example, the normative database stores data corresponding to a one-month time period (e.g., November 2005), but it does not store data corresponding to only a one-day time period (e.g., the one day time period of Nov. 5, 2005) as does the native database. Thus, the mapping entry 602a is used to map the native database criterion ID ‘110505’ 616 associated with the native database to the normative database criterion ID ‘1105’ 618 associated with the normative database.

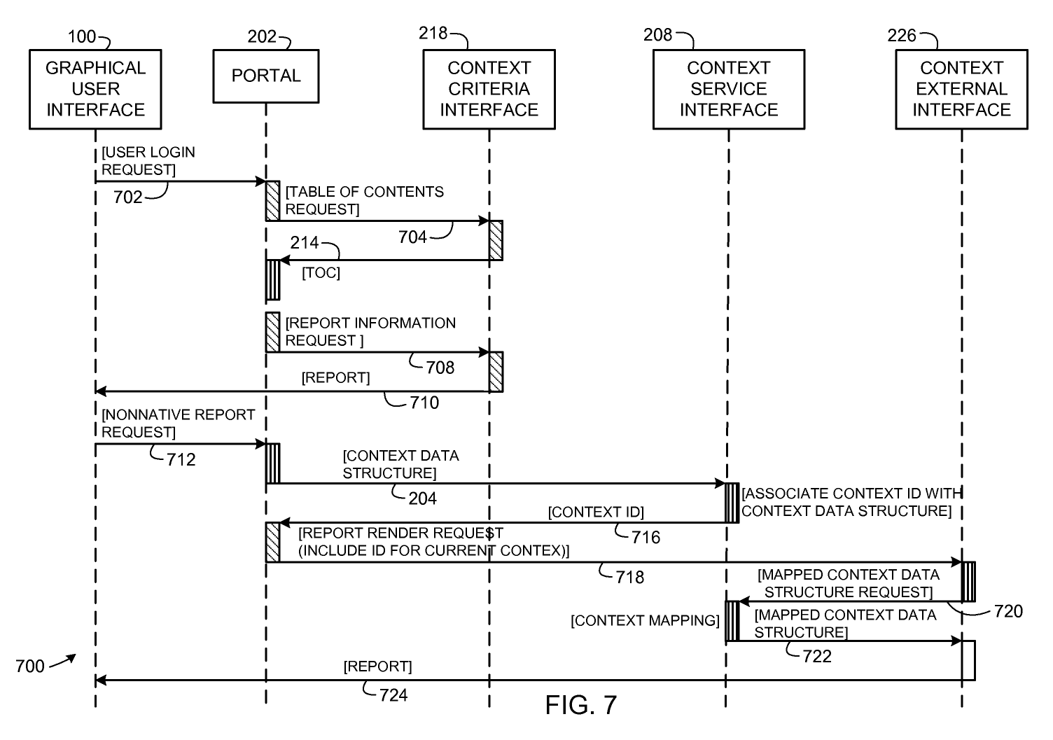

FIG. 8 is a flowchart representative of example machine readable instructions that may be executed by one or more entities of the example system 200 of FIG. 2 to enable the portal 202 of FIG. 2 to retrieve information (e.g., the report A information 102, the report B information 104, and/or the normative report information 106 of FIG. 1) from a plurality of separate data sources (e.g., the native data source 212 and/or the normative data source 220 of FIG. 2) without requiring a user to repeatedly provide selection criteria indicative of the information to be retrieved. Although the example machine readable instructions are described with reference to the flowchart of FIG. 8, other methods of implementing the example system 200 of FIG. 2 may additionally or alternatively be used. For example, the order of execution of the blocks depicted in the flowchart of FIG. 8 may be changed, and/or some of the blocks described may be rearranged, eliminated, or combined. Some of the operations of the flowchart of FIG. 8 described below are described in connection with an example timing diagram 700 of FIG. 7 representative of example communication transactions between entities of the example system 200 of FIG. 2.

Turning in detail to FIG. 8, initially, the GUI 100 (FIG. 1) communicates a user login request 702 (FIG. 7) to the portal 202 (block 802). The portal 202 then communicates a TOC request 704 (FIG. 7) to the context criteria interface 218 to, upon initial login, request a TOC (block 804). For example, the user may set the portal 202 to always default to retrieving a TOC from a particular data source or from a data source that the user was working with during a previous login session. Thus, if the default data source is the native data source 212 (or if the user was working with the native data source 212 during a previous login session), the portal 202 may request the TOC 214 associated with the native data source 212 at block 804. The portal 202 then receives the TOC 214 (FIG. 7) from the context criteria interface 218 (block 806), and the portal 202 applies a default context or a current context (block 808) based on the selection criteria in the TOC 214. For example, the portal 202 may use a default context if the user has set the portal 202 to, upon initial login, always default to a particular context (e.g., to particular selection criteria shown in the criterion selection fields 110a-c) or to a context that the user specified during a previous login session. Alternatively, the portal 202 may use a current context if the user, after an initial login, has specified particular selection criteria (e.g., selection criteria different from default selection criteria) via the criterion selection fields 110a-c.

The portal 202 then communicates a report information request 708 (FIG. 7) to the context criteria interface 218 to request report information (block 810). For example, the portal 202 may communicate the report information request 708 in response to a user selecting one of the report selectors 114b-c of FIG. 1. The context criteria interface 218 then causes the report rendering engine 216 (FIG. 2) to communicate a report 710 (FIG. 7) to the GUI 100 to render the report 710 having the requested information (block 812). For example, the report rendering engine 216 may generate the report 710 to include the report A information 102 (FIG. 1).

The portal 202 then receives a normative report request 712 (FIG. 7) from the GUI 100 (block 814). For example, the GUI 100 may communicate the normative report request 712 to the portal 202 in response to a user selecting the report selector 114d of FIG. 1. The portal 202 then uses the context manager 206 to generate the context data structure 204 (FIGS. 2 and 7) (block 816), and the context service interface 208 associates a context ID 716 (FIG. 7) with the context data structure 204 (block 818). The portal 202 then communicates a report render request 718 (FIG. 7) (which includes the context ID 716) to the context external interface 226 to request the normative application 222 to render a report (block 820). The context external interface 226 then communicates a mapped context data structure request 720 (FIG. 7) to the context service interface 208 to request a mapped context data structure (block 822). In the illustrated example, the mapped context data structure request 720 includes the context ID 716 to specify the context data structure 204 and to cause the context service interface 208 to map the selection criteria in the context data structure 204 to normative selection criteria in a mapped context data structure. In the illustrated example, the context service interface 208 uses the mapping table 224 of FIG. 2 to generate the mapped context data structure to include normative selection criteria mapped to the native selection criteria in the context data structure 204 as described above in connection with FIGS. 5 and 6.

The context service interface 208 then maps the context data structure 204 to the target application (block 824). For example, the data mapper 223 of the context service interface 208 can map the native selection criteria in the context data structure 204 to normative selection criteria corresponding to the normative application 222. The context service interface 208 then communicates a mapped context data structure 722 (FIG. 7) to the context external interface 226 (block 826), and the context external interface 226 causes the normative application 222 to communicate a report 724 (FIG. 7) to the GUI 100 to render the report 724 having the requested information (block 828). For example, the normative application 222 may generate the report 724 to include the normative report information 106 of FIG. 1. The process of FIG. 8 is then ended.

### Report Specification Preparation

The example methods, systems, apparatus, and/or articles of manufacture described herein may also be used to enable the preparation of report requests to be executed by third-party report generators. While the methods and apparatus described above include obtaining report information from the example normative data source 220, some third-party report generators may require that any access to one or more normative data sources occur by way of one or more customized applications, normative applications, tailored specifications, and/or external interfaces. In some circumstances, the third-party owns, operates, designs, and/or manages one or more front-end applications and/or interfaces to receive a tailored, modified or customized report specification, which contains instructions related to controlling the normative data source to accomplish report objectives. Report requests that provide, invoke, and/or otherwise submit the tailored report specification to such third-party report generators may require strict compliance with a communication syntax including, but not limited to a character syntax, a communication/programming language syntax, a programming format command/instruction sequence (e.g., order-of-operations, an ordered command sequence, etc.), and/or specialized function language to cause one or more report processing directives (e.g., pre-execution report directives, post-execution report directives, etc.) to be executed. As such, the methods and apparatus described above in connection with retrieving and/or otherwise assessing a TOC of the normative data source may not facilitate further access to the information contained therein, and one or more customized report requests may need to be generated to, for instance, comply with one or more syntax, instruction sequence(s), and/or specialized function language required by the normative data source.

The third-party report generators, which may include products and/or services offered by Cognos®, typically develop front-end access applications in-house and/or partner with other third party application developers to build, test, and/or implement custom report requests that satisfy one or more syntax and/or programmatic requirements (e.g., compliance with software development kits (SDKs)). In the event a user (e.g., a customer of the third-party report generator, an analyst, etc.) wishes to purchase and/or otherwise utilize the services of the third-party report generator, a work-order may be generated that includes the user's specifications so that a customized report request (e.g., a report specification) can be developed that satisfies one or more syntax requirements of the third-party report generator. The user must typically provide detailed specifications for each permutation of desired report output. In other words, one or more prompts, selections, identified data sources, and/or displays are statically defined by a report developer at report design time. At least one drawback of confining the development of report specifications at design time is that report reuse is sacrificed, a risk of redundant prompts increases, and/or a risk of additional reports that may require further user development time, testing time, deployment time, and/or other requirements. If a user (e.g., the customer, the analyst, etc.) later desires one or more changes (e.g., major changes, minor changes, etc.) to the selectable prompts and/or selects an alternate format of a base report (e.g., different chart-type, different charting options, etc.) prior to the one or more reports being generated by the third-party report generator, then additional design resources (e.g., time, money, technical programming resources, etc.) must be expended.

The methods and apparatus described herein provide the user with a greater degree of efficiency, timeliness, and/or cost savings when designing one or more report specifications to be used when requesting reports from the third-party report generator. Additionally, the methods and apparatus described herein may further maintain selection criteria (context and/or options that control rendering as described above) previously accessed and/or input by the user, and apply such selection criteria to the report specification prior to submission to the third-party report generator. As a result, user defined selections, saved selections, and/or recently used selection criteria may be dynamically applied to one or more report specifications without being constrained by extensive outside programming resources.

The illustrated example of FIG. 9 builds upon the illustrated example of FIG. 2 in which similar structure includes reference numerals as shown in FIG. 2, and will not be discussed again. However, the illustrated example of FIG. 9 includes a normative report engine 950 communicatively connected to the portal 202 and the context manager 206. The example normative report engine 950 is communicatively connected to any number of normative applications 222a, 222b, and 222c. Each of the example normative applications 222a-c may be associated with a third-party report generator (normative data source), such as Cognos®, SAP AG®, Oracle®, etc. Additionally, each of the example normative applications may include one or more associated normative data sources 220a, 220b, and 220c. As described above, access to one or more of the normative data sources 220a-c (third-party report generators) may not be allowed unless one or more properly formatted report specifications are provided to the corresponding normative application 222a-c, in which each report specification may include compliance with strict formatting requirements to function properly.

In operation, before the user requests one or more reports (via the example portal 202) from the normative data sources 220a-c, the normative report engine 950 retrieves an unmodified report specification specific to at least one of the normative data sources 220a-c and appends pre and post-execution report directives into the report specification (report design phase). Typically, the report specifications include XML code in which the normative report engine 950 adds one or more static HTML tags to be identified and executed by the normative report engine 950 at a later time (e.g., during a rendering request when the user requests one or more reports in connection with selection criteria). Additionally or alternatively, one or more static HTML tags may be inserted/injected manually by the user/report designer. To improve subsequent user efficiency related to future report design, blocks of XML code may be archived by the example normative report engine 950 for later implementation, thereby minimizing duplicative entry efforts. Such tags further include instructions to format and/or otherwise modify the report specification based on business requirements that state how to apply user selection criteria (context), but have no meaning for the target third-party report generator. In other words, the target third-party report generator ignores the tags that only apply relevant functionality for the example normative report engine 950. Example functionality realized by the report directives includes, but is not limited to, driving dropdown selection options in portal interfaces (e.g., dropdown menus, page level functions, export, print, reset to default context, etc.), replacing prompt values and data insertion, responding to conditional variable selections by a user, string substitution based on user selections (selection criteria) prior to report execution, table/chart column/row insertion/deletion, and/or table/chart sorting functions. As described in further detail below, the tags permit the user's selection criteria to be considered prior to the report specification being submitted to the third-party report generator, thereby allowing the user a dynamic and flexible manner of retrieving report output tailored to or modified for the user's needs without the need for costly third-party and/or in-house programming resources to develop the report specification(s).

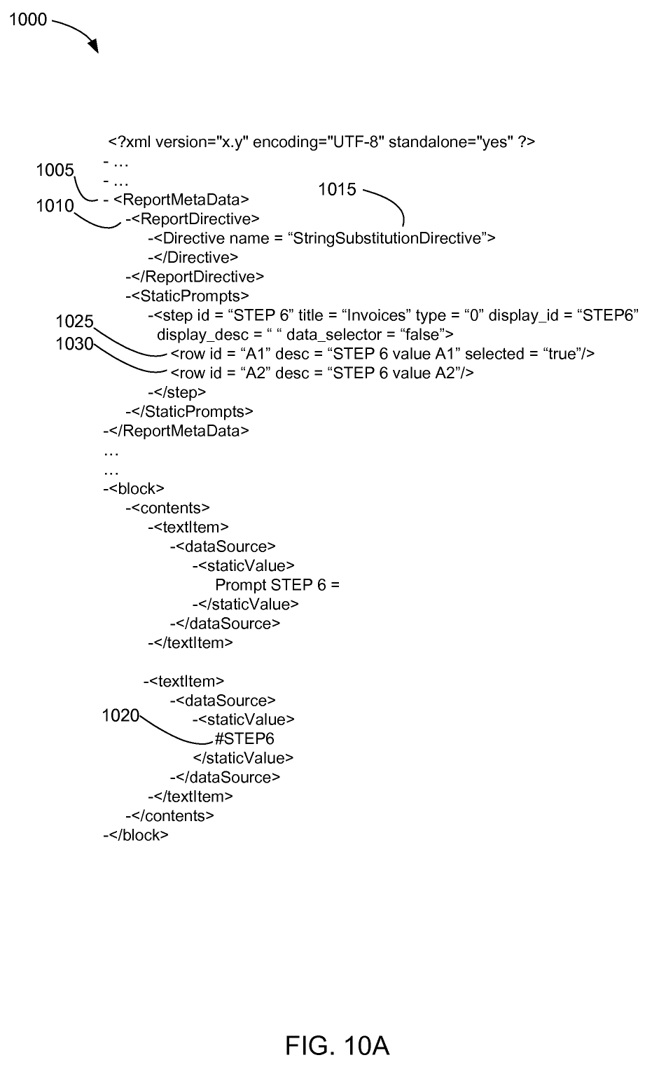

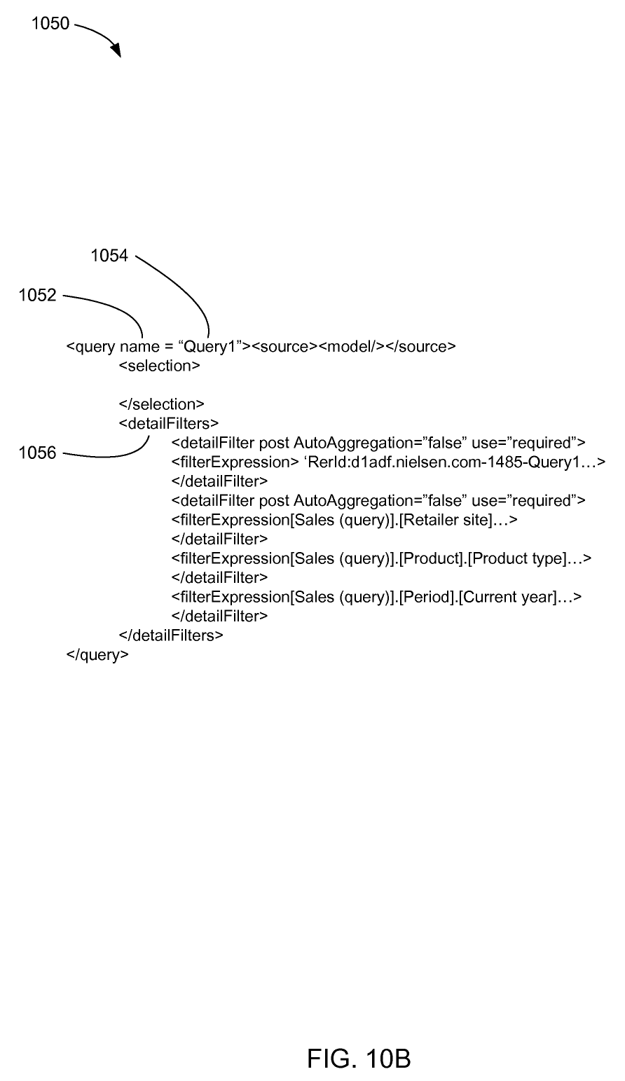

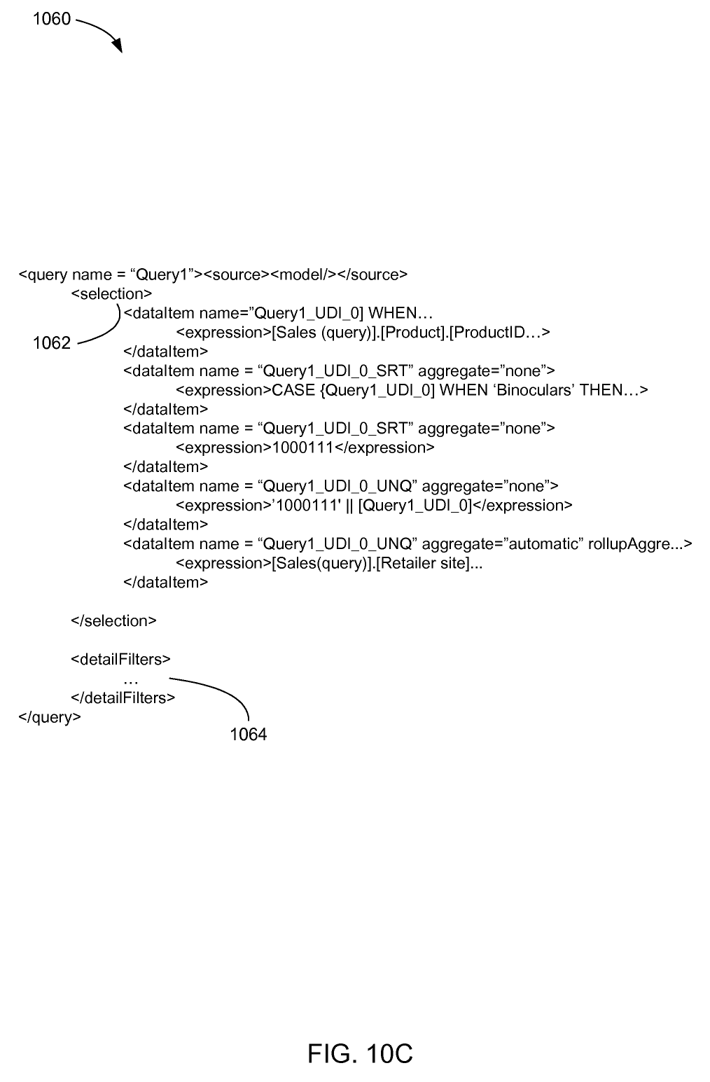

Turning to FIG. 10A, an example portion of a report specification 1000 is shown in further detail. An example ReportMetaData XML tag 1005 is relevant only to the example normative report engine 950, but is ignored by target third-party report generators. As described in further detail below, one or more XML tags related to report specification customization may be deleted after execution, but before being sent to the target third-party report generator. In other words, the one or more XML tags related to customization typically serve no purpose for the target third-party report generators. In the illustrated example of FIG. 10A, the ReportMetaData tag 1005 includes one or more report directives that may be executed by the example normative report engine 950 prior to submitting the report specification to the target third-party report generators. Instead, the example XML tags instruct the example normative report engine 950 to augment or modify the example report specification 1000 so that customized output may be obtained from the example third-party report generator(s). As such, the directives execute in view of the most recent user defined selection criteria before report generation. An example ReportDirective XML tag 1010 identifies one or more report directives that should be executed. An example directive named “StringSubstitutionDirective” 1015 allows the example normative report engine 950 to reference corresponding execution instructions from a report directive library, discussed in further detail below. Generally speaking, the example “StringSubstitutionDirective” 1015 may be used within report headers and/or footers to dynamically adjust the report specification to reflect a current session selection criteria (e.g., selections made by the user from within the example portal 202 prior to one or more request(s) to generate the report(s)). Additionally, the substitution directive 1015 includes one or more substitution tokens, such as the example text item “#STEP6,” 1020 which will be replaced after execution with specific data based on whether the user selected “A1” 1025 or “A2” 1030 prompts in the example portal 202 prior to the report generation request(s). While the example portion of the report request of FIG. 10A includes XML tag functionality related to string substitution, any number of additional report directives may, without limitation, be added in addition to or instead of those examples illustrated in FIG. 10A.

While the illustrated example of FIG. 10A includes the substitution token “#STEP6” 1020, the methods and apparatus described herein may include any number of tokens. For instance, an inventory of tokens, such as step identifiers, may be defined at runtime to search for token placeholders, such as $ {value}. In operation, an example directive searches for all instances of the $ {value} token, extracts one or more values therein, and then references a lookup table for corresponding replacement instructions. Upon identifying and/or otherwise locating one or more instances of the token (e.g., $ {value}), the example normative report engine 950 replaces the token instance with one or more corresponding runtime value(s). Token placeholders may include, but are not limited to canned (e.g., always available) tokens related to data scope (e.g., “$ {DataScope}”), tokens related to specific users (e.g., “${User}”), tokens related to specific data and/or data-types (e.g., “$ {Data}”), and/or tokens related to particular time(s) (e.g., “$ {Time}”).

Generally speaking, the methods and apparatus described herein facilitate an extensible manner of customizing one or more report specifications using report directives and/or tokens. Each report directive may facilitate a specific set of functionality for any given report specification of interest. Without limitation, the example report directive(s) described herein allow for alteration, injection, removal and/or substitution of the report specification of interest during runtime. As described above, the example report directives all for such modification to occur outside the traditional boundaries of design time, thereby improving opportunities for report specification reuse.

The methods and apparatus described herein are not limited to the example report directive associated with string substitution, as shown in FIG. 10A. Without limitation, report directives may include adjustment functionality directed to one or more aspects of the report specification. For example, a filter report directive may receive a list of queries to filter via where statements during runtime, such as one or more market constraints to apply to the report specification, and/or one or more product constraints. Report directives may also include, for example, data insertion functionality directed to one or more aspects of the report specification to adjust report queries, such as one or more report select statements.

In the illustrated example of FIG. 10B, an example portion of a report directive 1050 may receive information related to a single query 1052, such as “Query1” 1054. An example dimensional filter 1056 may be responsive to user selections at runtime to react to requests including, but not limited to market specific requests, product specific requests, and/or time-period specific requests. In the illustrated example of FIG. 10C, an example portion of a report directive 1060 may process each fact and/or information from an end user via one or more selection statements 1062. Any resulting final report specification may, in the illustrated example of FIG. 10C, incorporate the user selection as a dimensional filter 1056 as shown in FIG. 10B.

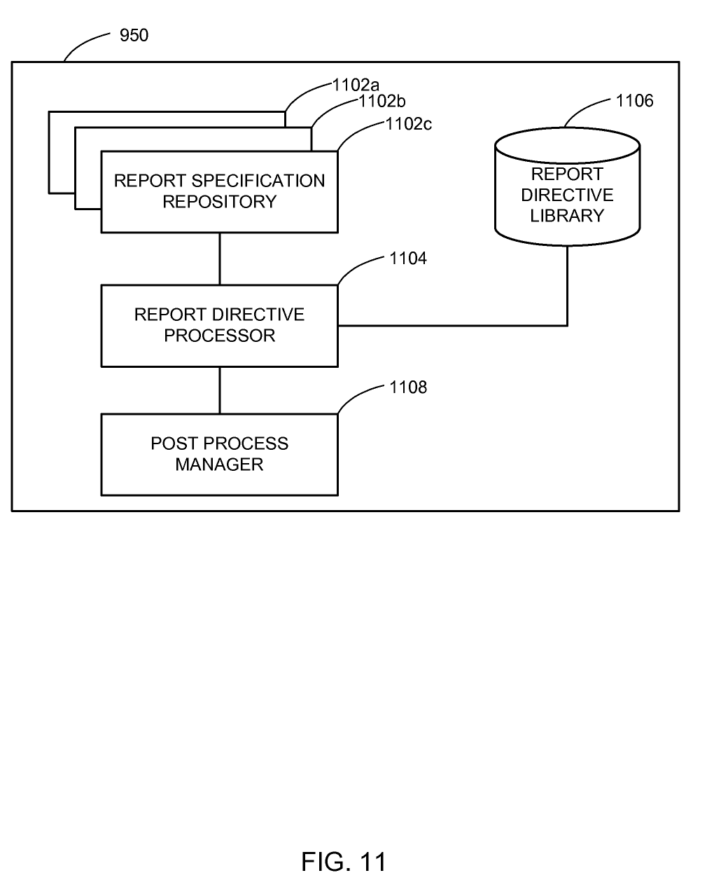

Turning to FIG. 11, the example normative report engine 950 of FIG. 9 is shown in further detail. In the illustrated example of FIG. 11, the normative report engine 950 includes one or more report specification repositories 1102a, 1102b, and 1102c. Each of the example report specification repositories 1102a-c includes one or more report specifications that are compliant with the requirements of the target third-party report generator. For example, as discussed above, each third-party report generator may require a particular specification format, nomenclature, and/or order of operations. As such, the example report specification repositories 1102a-c may be invoked based on which target third-party report generator was selected by a user at the example portal 202. The one or more report specifications stored in the example report specification repositories 1102a-c may include such report specifications originally designed and/or otherwise developed by an entity associated with (e.g., contracted by) a third-party report generator. As described above, such entities associated with and/or controlled by the third-party report generators may charge one or more fees in the event that a user wishes to edit, modify, and/or design a report specification. As such, each of the report specifications stored in the example report specification repositories 1102a-c may be built, designed, and/or otherwise prepared during a design-time by a report author unassociated with the third-party report generator to include one or more report directives, thereby circumventing the one or more fees, charges, etc. associated with contracting for report specification design services. In other words, each report specification stored in the report specification repositories 1102a-c include report author generated XML tag placeholders that are only responsive to a report directive processor 1104. The example report directive processor 1104 scans each report specification in response to a request to generate one or more reports. When the report directive processor 1104 identifies a report directive based on the XML tag, a query is made to a report directive library 1106 for corresponding directive instructions.

Directive instructions are not limited to pre-report generation events, but may also include one or more post report-generation events. Post report-generation events are processed by the example post-process manager 1108 and include, but are not limited to report data formatting directives, data sorting directives, chart and/or graph type, style, and/or color directives, and/or application of additional dropdown selection buttons on the report displayed to the user on the example portal 202. One example post-report directive may instruct the report to re-execute upon state changes to one or more dropdown selectors on the portal 202, such as when the user makes a change to the market criterion selection field 110a shown in FIG. 1.

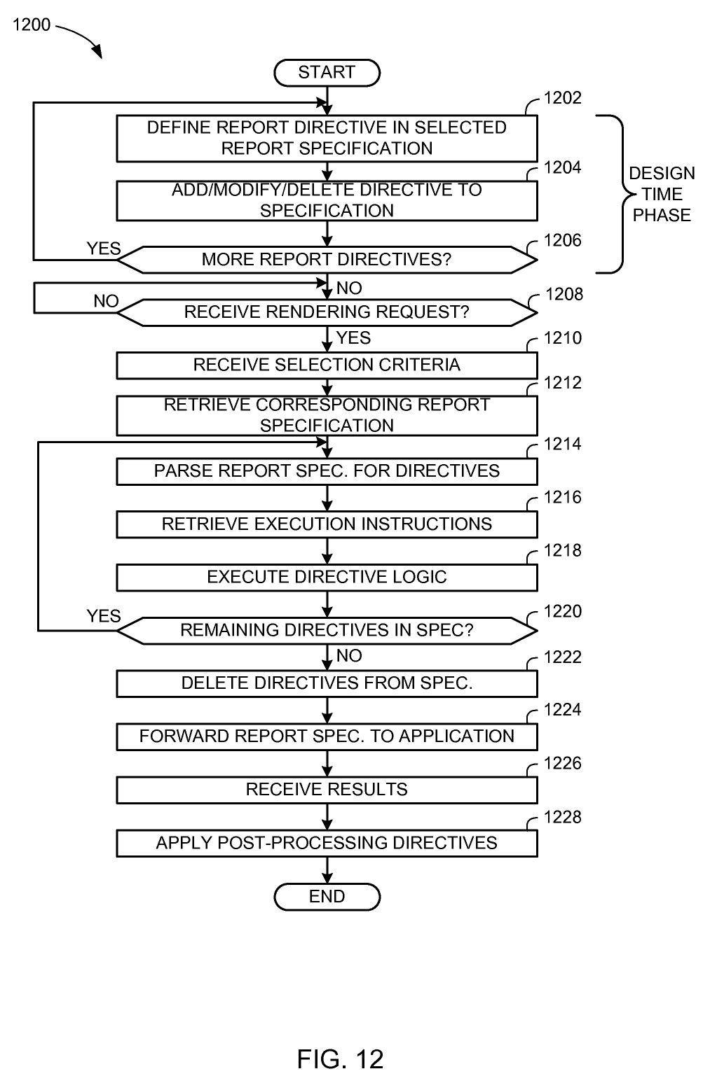

The normative report engine 950, the report specification repositories 1102a-c, the report directive processor 1104, the report directive library 1106, and/or the post-process manager 1108 may be implemented using any combination of hardware, firmware, and/or software. For example, one or more integrated circuits, discrete semiconductor components, or passive electronic components may be used to implement these structures. Additionally or alternatively, some or all of the normative report engine 950, the report specification repositories 1102a-c, the report directive processor 1104, the report directive library 1106, and/or the post-process manager 1108, and/or parts thereof, may be implemented using instructions, code, and/or other software and/or firmware, etc. stored on a machine accessible medium that, when executed by, for example, a processor system (e.g., the example processor system 1310 of FIG. 13), perform the operations represented in the flowchart of FIG. 12. In the illustrated example, some or all of the normative report engine 950, the report specification repositories 1102a-c, the report directive processor 1104, the report directive library 1106, and/or the post-process manager 1108 may be distributed among various network entities (e.g., various servers) in the example system 900. However, in alternative example implementations, some or all the normative report engine 950, the report specification repositories 1102a-c, the report directive processor 1104, the report directive library 1106, and/or the post-process manager 1108 may be implemented using the same network entity (e.g., the same server).

FIG. 12 is a flowchart representative of example machine readable instructions that may be executed by one or more entities of the example system 900 of FIG. 9 and/or the normative report engine 950 of FIG. 11 to enable preparation of report requests. Although the example machine readable instructions are described with reference to the flowchart 1200 of FIG. 12, other methods of implementing the example system 900 and/or the normative report engine 950 may additionally or alternatively be used. For example, the order of execution of the blocks depicted in the flowchart of FIG. 12 may be changed, and/or some of the blocks described may be rearranged, eliminated, or combined.

Turning in detail to FIG. 12, initially the example report directive processor 1104 operates in a report specification design-time phase (blocks 1202, 1204, and 1206). During the design-time phase, each selected report specification is evaluated, in which, for example, a report directive is defined or selected from the report directive library 1106 (block 1202). As described above, the selected report specification may, initially, be in an unmodified (e.g., original) state as designed and/or otherwise prepared by the third-party report generator, and/or an entity (e.g., a software developer) contracted by the third-party report generator to provide one or more report specifications. In the event that an existing report directive does not exist in the report directive library 1106 to suit desired report objectives, one or more directives designed and/or otherwise defined (block 1202) may be saved to the report directive library 1106 for future use. The example report directive processor 1104 saves the selected/defined/added/modified report directive to one or more report specifications (block 1204) taking into consideration any specific design constraints imposed by the target third party report generator 220a-c (normative data sources) and/or unique formatting constraints required by one or more normative applications 222a-c. As described above, each third-party report generator 220a-c may have unique syntax and/or order-based requirements related to report specification XML code and/or tags. Generally speaking, the report directive processor 1104 transforms a standard report specification designed to be executed by the target third-party report generators 220a-c and inserts placeholder directives to be subsequently executed by the example report directive processor 1104 in connection with user selection criteria. If there are additional report directives to add to a selected report specification (block 1206), control returns to block 1202.

The example report directive processor 1104 monitors for a rendering request (block 1208) (e.g., a request from the portal 202 to generate a report). When a request is received (block 1208), the report directive processor 1104 receives selection criteria from the user that is related to the desired report (block 1210). The received selection criteria includes details, such as user selections for each prompt exposed to the desired report, information about the user (as entered via the portal 202 and/or as maintained as context), and/or a type of report execution desired. For example, selection criteria information received may include, but is not limited to a market area designation, such as via the market criterion selection field 110a, the product criterion selection field 110b, and/or the desired period selection field 110c, all of which are shown in FIG. 1. In some examples, information from the market criterion selection field 110a may identify which of the one or more target third-party report generators is best suited to handle the report request. The example report directive processor 1104 selects, based on the received selection criteria, and/or otherwise retrieves a report specification from the best suited third-party report generator (block 1212).

The received report specification is parsed to locate a report directive (block 1214). As discussed above, the example report directive processor 1104 may search for the example XML tag “ReportMetaData” 1005, as shown in FIG. 10A. In response to locating a report directive (block 1214), a query is made to the example report directive library 1106 to retrieve associated directive instructions (block 1216), such as the example directive related to string substitution as described above in connection with FIG. 10A. Such identified directives are executed (block 1218), which tailors or modifies the report specification in a manner consistent with the user selection criteria as it existed just prior to making the rendering request (block 1208). If remaining directives reside in the report specification yet to be executed (block 1220), control returns to block 1214. In some design time phases (blocks 1202 through 1206), a hidden tag may be entered into the last report directive embedded within the report specification, which signals to the example report directive processor 1104 that further searching for more report directives is not necessary.

In the event that one or more report directives are deemed proprietary, sensitive, and/or the user prefers not to inform the third-party report generator of one or more custom modifications to the report specification, the example report directive processor 1104 may remove all or some of the report directives after they have been executed (block 1222). The report specification, after all report directives related to pre-processing have been executed, is forwarded to the target third-party report generator (block 1224). The report directive processor 1104 receives results from the target third-party report generator (block 1226) and provides such results to the post-process manager 1108 for application of post-processing directives and presentation to the user via the portal 202 (block 1228).

FIG. 13 is a block diagram of an example processor system 1310 that may be used to execute the example machine readable instructions of FIGS. 8 and 12 to implement the example systems, apparatus, and/or methods described herein. As shown in FIG. 13, the processor system 1310 includes a processor 1312 that is coupled to an interconnection bus 1314. The processor 1312 includes a register set or register space 1316, which is depicted in FIG. 13 as being entirely on-chip, but which could alternatively be located entirely or partially off-chip and directly coupled to the processor 1312 via dedicated electrical connections and/or via the interconnection bus 1314. The processor 1312 may be any suitable processor, processing unit or microprocessor. Although not shown in FIG. 13, the system 1310 may be a multi-processor system and, thus, may include one or more additional processors that are identical or similar to the processor 1312 and that are communicatively coupled to the interconnection bus 1314.

The processor 1312 of FIG. 13 is coupled to a chipset 1318, which includes a memory controller 1320 and an input/output (I/O) controller 1322. A chipset typically provides I/O and memory management functions as well as a plurality of general purpose and/or special purpose registers, timers, etc. that are accessible or used by one or more processors coupled to the chipset 1318. The memory controller 1320 performs functions that enable the processor 1312 (or processors if there are multiple processors) to access a system memory 1324 and a mass storage memory 1325.

The system memory 1324 may include any type of volatile and/or non-volatile memory such as, for example, static random access memory (SRAM), dynamic random access memory (DRAM), flash memory, read-only memory (ROM), etc. The mass storage memory 1325 may include any desired type of mass storage device including hard disk drives, optical drives, tape storage devices, etc.

The I/O controller 1322 performs functions that enable the processor 1312 to communicate with peripheral input/output (I/O) devices 1326 and 1328 and a network interface 1330 via an I/O bus 1332. The I/O devices 1326 and 1328 may be any type of I/O device such as, for example, a keyboard, a video display or monitor, a mouse, etc. The network interface 1330 may be, for example, an Ethernet device, an asynchronous transfer mode (ATM) device, an 802.11 device, a digital subscriber line (DSL) modem, a cable modem, a cellular modem, etc. that enables the processor system 1310 to communicate with another processor system.

While the memory controller 1320 and the I/O controller 1322 are depicted in FIG. 13 as separate functional blocks within the chipset 1318, the functions performed by these blocks may be integrated within a single semiconductor circuit or may be implemented using two or more separate integrated circuits.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

1. A computer implemented method to modify a report specification, comprising:
receiving a request to generate a report, the request associated with selection criteria;
receiving a report specification associated with the selection criteria;
parsing the report specification to identify a report directive;
querying a report directive library to retrieve instructions associated with the identified report directive;
executing the retrieved instructions to modify the report specification based on the selection criteria; and
generating an output including the modified report specification.

2. A method as defined in claim 1, wherein the selection criteria comprises at least one of user information, a report type, market information, product information, or time period information.

3. A method as defined in claim 1, wherein the report specification includes a communication syntax to communicate with a first data source.

4. A method as defined in claim 3, wherein the first data source comprises at least one of a native data source or a normative data source.

5. A method as defined in claim 3, wherein the communication syntax comprises at least one of a specialized function language, an ordered command sequence, or a programming format.

6. A method as defined in claim 1, wherein the report specification comprises extensible markup language (XML) code to retrieve data from a first data source.

7. A method as defined in claim 6, wherein the XML code conforms to a communication syntax associated with the first data source.

8. A method as defined in claim 1, wherein parsing the received report specification further comprises identifying an extensible markup language tag indicative of the report directive.

9. A method as defined in claim 1, wherein the report directive invokes portal interface dropdown selections.

10. A method as defined in claim 9, wherein the portal interface dropdown selections comprise at least one of page level functions, export functions, or print functions.

11. A method as defined in claim 1, wherein the report directive invokes replacement of a portal prompt value.

12. A method as defined in claim 1, wherein the report directive invokes string substitution of the report specification.

13. A method as defined in claim 1, wherein the report directive invokes conditional variable functions in a user portal.

14. A method as defined in claim 1, wherein modifying the report specification further comprises invoking post-report generation events.

15. (canceled)

16. A computer implemented method to modify a report specification, comprising:
selecting a report specification associated with a first data source;
defining a first report directive to be compliant with a communication syntax associated with the first data source;
appending an extensible markup language (XML) tag to the report specification to form a modified report specification, the XML tag to invoke the first report directive; and
generating an output of the modified report specification.

17. A method as defined in claim 16, wherein defining the first report directive further comprises generating directive instructions to be executed when the first report directive is invoked.

18. A method as defined in claim 16, further comprising defining a second report directive to be compliant with the communication syntax associated with the first data source, at least one of the first or second report directives to be invoked in response to a report request.

19. An apparatus to modify a data source report specification, comprising:
a portal to receive a request to generate a report;
a context service interface to receive selection criteria associated with the request to generate the report;
a report specification repository to store a plurality of report specifications, the context service interface to retrieve a report specification from the plurality of report specifications from the report specification repository;
a nonnative report engine to parse the report specification for a report directive; and
a report directive processor to execute the report directive, the report directive to modify the report based on the received selection criteria.

20. An apparatus as defined in claim 19, further comprising a report directive library to store instructions associated with the report directive.

21. An apparatus as defined in claim 19, further comprising a post process manager to invoke a post report generation event based on the report directive.

22-34. (canceled)
